(19) United States
(12) Patent Application Publication
(10) Pub. No.: US 2004/0254949 A1
(43) Pub. Date: Dec. 16, 2004

(54) Frame work for storing, retrieving and displaying real-time data

(75) Inventor: Raja Amirthalingam, Columbus, OH (US)

Correspondence Address: Michael M. Rickin, Esq., ABB Inc., Legal Department - 4U6, 29801 Euclid Avenue, Wickliffe, OH, 44092-1832, US

(73) Assignee: ABB Inc.

(21) Appl. No.: 10/461,186

(22) Filed: Jun. 13, 2003

(51) Int. Cl. G06F 17/00

(52) U.S. Cl. 707/101

(57) ABSTRACT

A frame work for storing, retrieving and displaying real-time data. The frame work includes software known as tools for data acquisition, that is, logging, file conversion and data analysis/display. Scalar and array type data are simultaneously handled during data logging and further processing. The data logging tool creates short term data in a binary file format and the file conversion software acquires long term data from the short-term data. Process condition based conversion and periodic conversion are also included in the architecture. Each of the three components of the frame work allows for user selection of parameters to maximize the benefit of the tools. The data display component offers automatic or user input based switching between the live data (online) and history data (offline) modes according to computational intensity.

### 1. FIELD OF THE INVENTION

This invention relates to a client to real-time data server and more particularly to the storing, retrieval and display of that data.

### 2. DESCRIPTION OF THE PRIOR ART

Real-time data refers to a collection of time-value pairs of one or more process variables. Real-time data servers publishing real-time data of the process variables based on data-change-event are common in the chemical, oil, pulp and paper, and other industries. These servers often leave the burden of deciding on how to use them to the client application developers and end users.

A data logger is one such important client application that stores the data obtained from the real-time server in a manner by which it can be retrieved later when required. Some of the common uses of such retrieved data is in troubleshooting, performance evaluation, graphical visualization and reporting, etc. Data logging tools (commonly known as historians) are available commercially from vendors such as as Matrikon Inc. (http://www.matrikon.com), Canary Labs (http://www.canarylabs.com), ifak system GmbH (http://www.ifak-system.com), and Measuresoft Development Ltd. (http://www.measuresoft.com), etc. The existing technology common among these tools is shown in FIG. 1.

As is shown in FIG. 1 the data historian 2 can be connected to the real-time servers 1 to collect data into a data-base and offers data base connectivity for client applications. Client applications such as data viewer 3 in turn connect to the data-base and display the data profiles. Such data viewing applications can also be connected to the real-time servers for continuous online update of the profiles. Some vendors (for example, Matrikon) offer solutions for importing data into a Microsoft® Excel spreadsheet 4.

One of the many limitations of the existing logging tools is the inability to cater to both the needs of short term and long term logging with appropriate importance on various elements of the data logging task. Another key deficiency among the existing tools is their inability to handle array type variables explicitly.

From an advanced user perspective, the current technology does not offer the required amount of flexibility for obtaining only the desired data from the super set. Some applications do offer a trigger mechanism for starting and stopping logging based on conditions that can be defined on process variables. But, the user requirement goes beyond simply triggering the start and stop of the data logging process.

A typical scenario that cannot be handled by the current day technology is the following:

(a) continuously log data,

(b) investigate the data for certain abnormalities by looking at the profiles during the logging process,

(c) specify the abnormality in a mathematical form to identify instances of such abnormality in the past, present, and in the future,

(d) obtain the data around such abnormality with the specified time boundaries related to such abnormalities, and

(e) convert such extracted data to a form that can be used outside the application with its own or some third party analysis tool.

Most data analysis and viewing tools available with data logging tools offer the flexibility of being used with the live data (online) or with the history data (offline). But, none of them offer automatic, or user input based switching between the online and offline modes of the tool. Based on the type of analysis involved in the viewing, much intelligence has to be built into the tool to automatically switch between the online and offline mode but such switching is not available at this time with any data logging tool.

The difference between data obtained from the historian and the real-time server is often very minimal in the current technology because the data obtained from the server is directly stored in most cases in the historian with all the original attributes. In other words, a simple copy-paste type of strategy is used in storing the real-time data which may be desired in some cases but, re-organizing the data in a different form in accordance with the present invention has many advantages including quick retrieval of the data.

Online/offline process data in its original form contains the timely behavior of one or more processes often identified by tag names. The design of a tool/equipment for handling such data decides the extent of its usefulness in the real world. By the way of design, one may change many facets of a data handling tool/equipment. The examples of such facets include: (1) the user interface architecture, (2) the data model, (3) the modular design of a tool and interconnectivity between various modules, (4) functionalities offered by the tool, and (5) extendibility of the modules. The present invention makes contributions in all the five areas in the design of the new tool/equipment.

Scalar data are common and obvious to a layman where as array data are not so obvious. A temperature measurement in a stirred tank reactor when measured at a regular time intervals (for example, every second), constitutes scalar time dependent data. Plotting time versus temperature yields a profile indicating the variations of temperature with time. If the reactor is not a stirred tank reactor and rather a natural convection reactor where the temperature varies across the volume of the reactor, then temperatures in various locations versus time would be a representative reactor temperature data. This is a typical example for the array data when the temperatures of the reactor is stored as a single time-dependent variable. A similar example would be the moisture content of the paper in production in a paper machine in the cross direction. With various sensors distributed in the cross direction, the spatial distribution of moisture content versus time is actually an array data.

The characteristics of the scalar and array type of data in a plant-wide process are different and the present invention allows for simultaneous handling of these different data types during data logging and further processing in an efficient manner. As mentioned above, handling array data becomes easier under the data structure of the present invention.

Computer networking is an integral part of the data logging, retrieval, and display. When many computers are connected together to communicate with each other they have formed a network and each computer is referred to as a node. In general, real-time data servers, client applications for data-logging, displaying, etc. may be running in the same node or in different nodes connected by a network. For the embodiment of the invention described herein, no assumption is made regarding any network and the execution of individual applications that are part of the overall logging framework can be either within the same computer or across computers connected via the network.

### SUMMARY OF THE INVENTION

A method for storing and retrieving scalar and array data associated with one or more processes from a real time server. The method comprises:

a. receiving predetermined categories of the scalar and array data simultaneously from the real time server, the predetermined categories comprising good data and uncertain data;

b. reorganizing the received data into a predetermined structure to accommodate the scalar and array data;

c. categorizing the good data as reliable data and resetting all of the received scalar and array data that is in the category of unreliable data to a constant large positive value of data;

d. saving the good data and the data of constant large positive values as short term data;

e. periodically at one frequency constructing long term data from the short term data; and

f. converting, one time or periodically at another frequency, based on predetermined selection criteria that defines predetermined desired segments of data:

(i) short term data into a selected set of data and in a selected file format; or

(ii) long term data into a selected set of data and in a selected file format.

A method for storing, retrieving and displaying scalar and array data associated with one or more processes from a real time server. The method comprises:

a. receiving predetermined categories of the scalar and array data simultaneously from the real time server, the predetermined categories comprising good data and uncertain data;

b. reorganizing the received data into a predetermined structure to accommodate the scalar and array data;

c. categorizing the good data as reliable data and resetting all of the received scalar and array data that is in the category of unreliable data to a constant large positive value of data;

d. saving the good data and the data of constant large positive values as short term data;

e. periodically at one frequency constructing long term data from the short term data;

f. connecting a display tool to the short term and long term data for historical data display purposes;

g. connecting the display tool to the real time server for on-line data display purpose; and

h. switching between on-line and off-line data based on computational requirements of the type of display.

A system for storing and retrieving scalar and array data associated with one or more processes. The system comprises:

a real time data server providing the scalar and array data associated with the one or more processes;

means for receiving predetermined categories of the scalar and array data simultaneously from the real time server, the predetermined categories comprising good data and uncertain data;

means for reorganizing the received data into a predetermined structure to accommodate the scalar and array data;

means for categorizing the good data as reliable data and resetting all of the received scalar and array data that is in the category of unreliable data to a constant large positive value of data;

means for saving the good data and the data of constant large positive values as short term data;

means for periodically at one frequency constructing long term data from the short term data; and

means for converting, one time or periodically at another frequency, based on predetermined selection criteria that defines predetermined desired segments of data:

(i) short term data into a selected set of data and in a selected file format; or

(ii) long term data into a selected set of data and in a selected file format.

A system for storing, retrieving and displaying scalar and array data associated with one or more processes. The syetem comprises:

a real time data server providing the scalar and array data associated with the one or more processes;

means for receiving predetermined categories of the scalar and array data simultaneously from the real time server, the predetermined categories comprising good data and uncertain data;

means for reorganizing the received data into a predetermined structure to accommodate the scalar and array data;

means for categorizing the good data as reliable data and resetting all of the received scalar and array data that is in the category of unreliable data to a constant large positive value of data;

means for saving the good data and the data of constant large positive values as short term data;

means for periodically at one frequency constructing long term data from the short term data;

means for connecting a display tool to the short term and long term data for historical data display purposes;

means for connecting the display tool to the real time server for on-line data display purpose; and

means for switching between on-line and off-line data based on computational requirements of the type of display.

### DESCRIPTION OF THE DRAWING

FIG. 1 shows a prior art data logger.

FIG. 2 shows the architecture for the present invention.

FIG. 3 shows the structure of the data manager for the data from the real time data server of FIG. 2.

FIGS. 4-7 show screen shots of the data acquisition, that is, the logger tool of FIG. 2.

FIG. 8 shows the working principle of the data logging tool.

FIG. 9 shows a screen shot for the auxiliary tool of the present invention.

FIG. 10 shows the working principle of the auxiliary tool.

FIG. 11 shows the variables used in the resampling algorithm as described in FIG. 12.

FIG. 13 shows the schematic description of the negative and positive offsets for a single point condition specification.

FIG. 14 shows the schematic description of the negative offset for the start condition and the positive offset for the stop condition.

FIG. 15 shows the schematic description of the negative and positive offsets for both the start and stop conditions if the requirement is to obtain two data sets around those conditions.

FIG. 16 shows a screen shot for how the start and stop conditions are specified.

FIG. 16a shows the user options for the auxiliary tool.

FIG. 17 shows the working principle of the data display/viewer tool of the present invention.

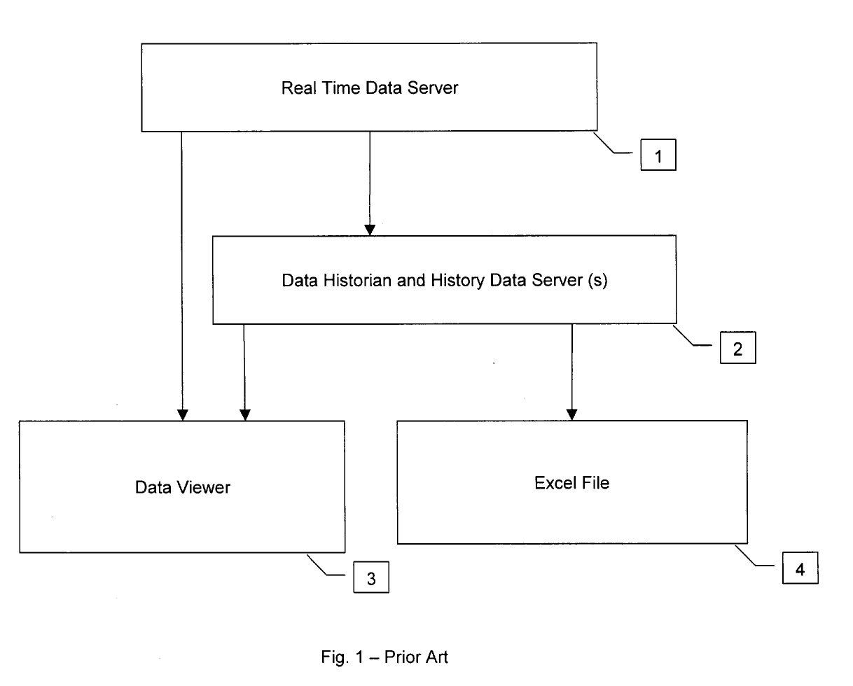

### DESCRIPTION OF THE PREFERRED EMBODIMENT(S)

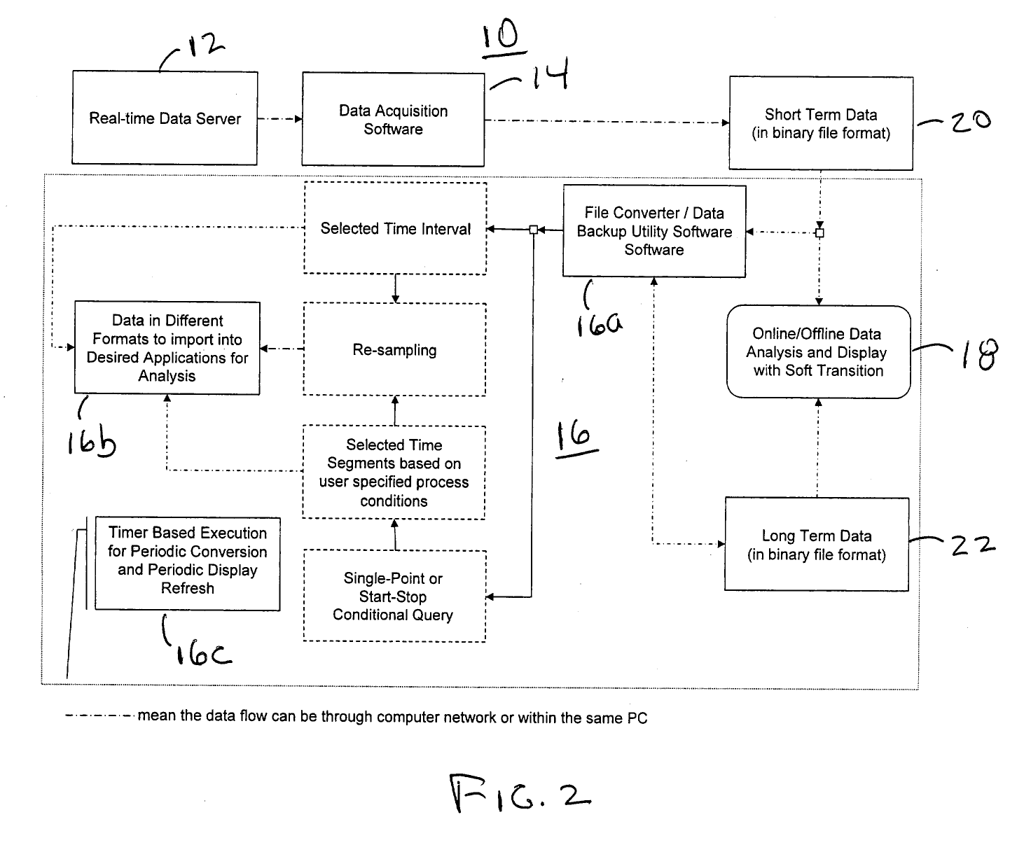

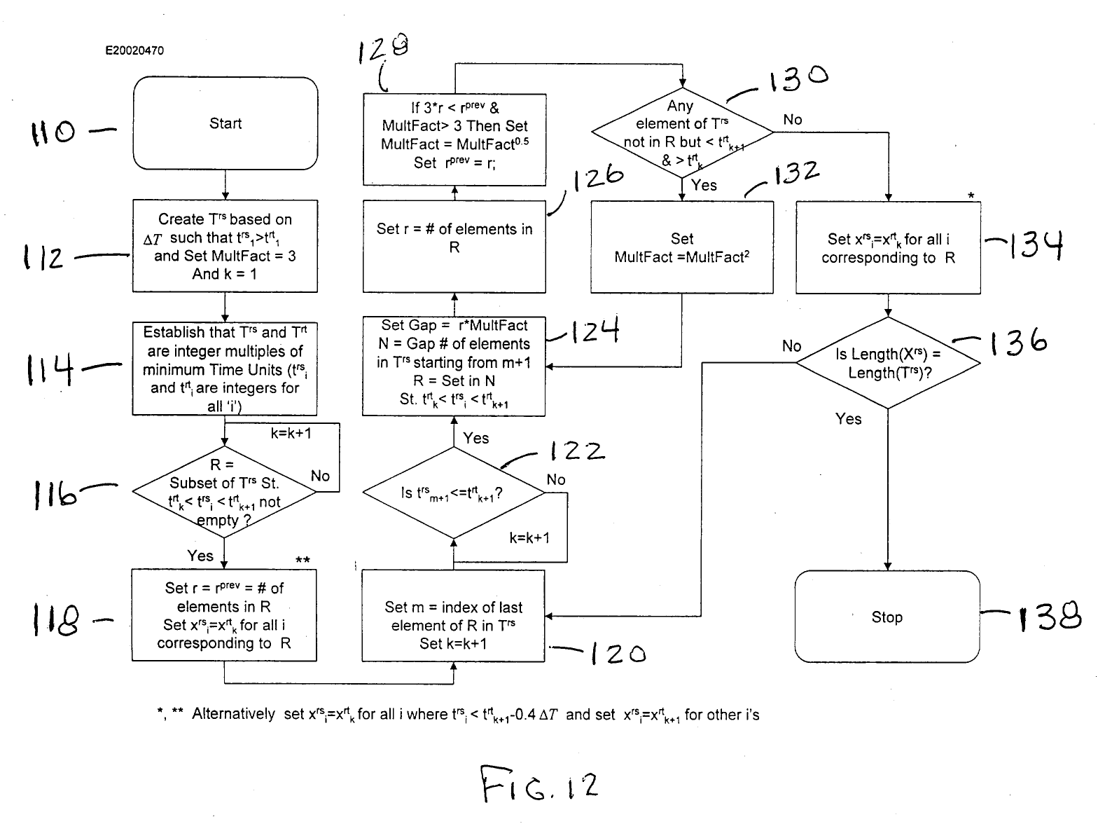

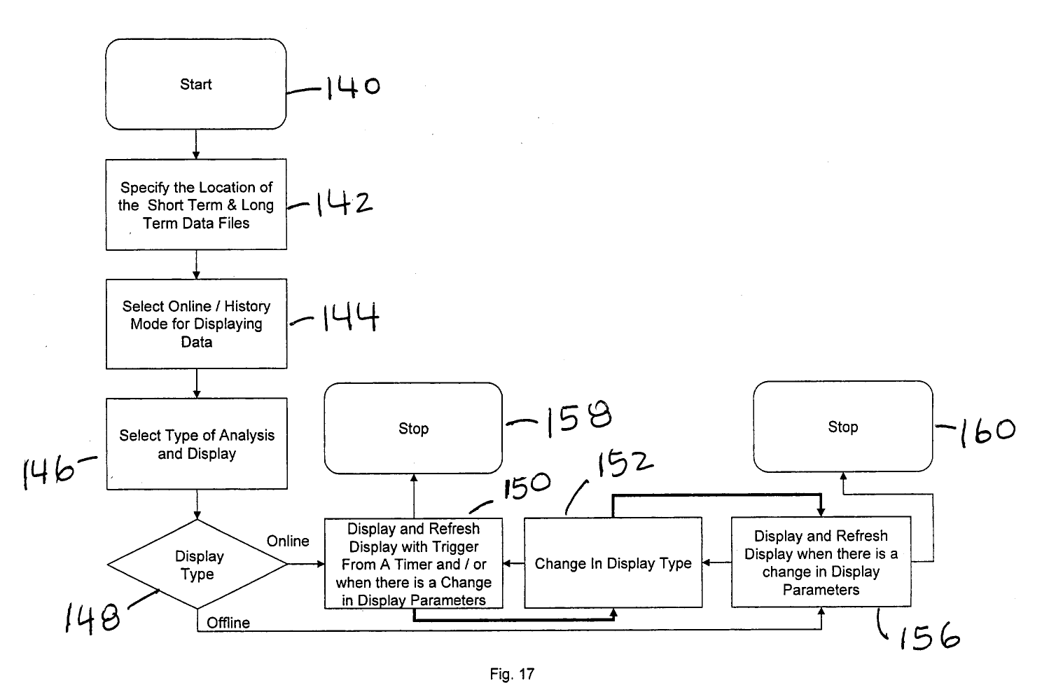

Referring now to FIG. 2 there is shown the architecture 10 for the present invention. As is shown in FIG. 2, the present invention has data acquisition software 14, file conversion software (the auxiliary tool) 16 and data analysis/display software 18. Auxiliary tool 16 includes 16a, 16b and 16c which are brief descriptions of the data flow in the tool. The working principle of auxiliary tool 16 is shown in detail in FIG. 10 and the working principle of data analysis/display software 18 is shown in detail in FIG. 17. The interconnections between the software 14, 16 and 18 and various data locations such as real-time data server 12 and the short term data 20 and the long term data 22 are shown in FIG. 2.

The data acquisition software 14, that is, the logger, obtains data from the real-time data server 12. The data arrives as data that is classified as “good” and data that is classified as “uncertain” data. As it arrives, the data is mainly categorized into two types. The “good” data is categorized as reliable data and all of the other data, that is, the uncertain data, is categorized as unreliable data. Except for the completely reliable data, all the remaining data values are changed to a constant large positive value and the entire received data are stored with the time stamp. Array tags and scalar tags are separated from each other and stored in two different formats.

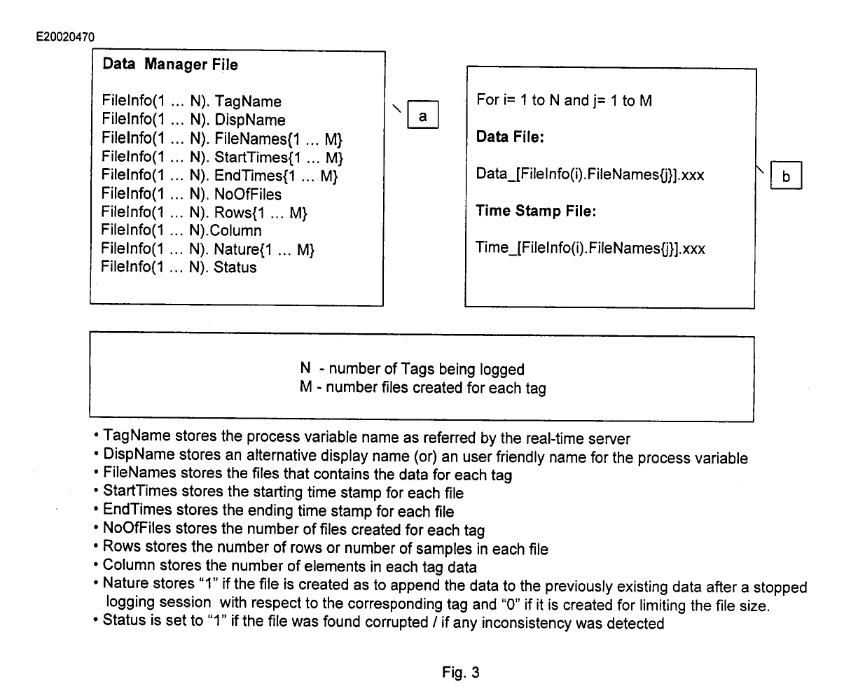

The data is organized with three different levels namely, data manager level, time-stamp level, and data level. The structure of the data manager is shown in FIGS. 3a and 3b.

As is shown in FIG. 3a, the data manager contains a single variable called FileInfo with the fields, TagName, DispName, etc. The TagName field is the name by which any particular process variable is identified by the server. The DispName (display name) field is a nickname added when the tag name is inconvenient for later use due to its length, cryptic name, etc.

The maximum index value of the variable is determined by the number of tags being logged. In order to allow the user to optimize the retrieval speed, the maximum size of a single file that contains the data is a configurable parameter which gives rise to multiple files for each tag. The index of the fields, FileNames, StartTimes, EndTimes, Rows, and Nature for each tag ranges from 1 to the number of files created for that tag. The entry in the FileNames field for each index is used as suffix for naming the actual Data and TimeStamp Files as shown in FIG. 3b.

The field ‘Column’ is used for differentiating between an array tag and a scalar tag, and is 1 when the tag is scalar and greater than 1 for array tags and the actual value is based on the array size. The Status field is used for flagging the inconsistency if determined during the frequent consistency check of the overall data set. The field ‘Nature’ stores the information about breaks created in the data for each tag either manually (due to stopping and then start logging any tag(s)) or automatically (due to a system crash). If the value of the field ‘Nature’ is 0 for any particular tag, then it means the file was created by the application when the precedent file for that tag reached the maximum allowable size. If the value of the field ‘Nature’ is 1, then it means this file was created new at the restart of the application when the new data was chosen to be appended to the old data.

Another important user parameter in configuring the Data Acquisition tool 14 is the maximum overall data size. With this parameter, when the overall data size reaches the maximum allowed value, the oldest files for each tag is discarded, however, when certain tags have less than the predetermined minimum number of files, the file deletion process is bypassed for those tags. The third parameter in configuring the Data Acquisition tool 14 is the maximum time duration. This parameter is used to discard a file of a tag when the last data in that file is older than the required past data specified by a parameter called maximum time duration.

Based on the described data logging design, real-time data is cached and based on a predetermined time interval, every time when a new data set is ready for a new update, the data manager file is updated and so are the data files and time-stamp files. At any instance, there will be only one active file per tag even if M is greater than 1 as per the description for FIG. 3a. A copy of the file manager file and all the active files is copied to a sub-folder called Transient for several reasons the most important of which are for consistency checking and for separating read and write of the data files.

The data acquisition software, that is, the logger 14 in the form described above creates short-term data 20 in a binary file format. Using the short-term data as the base level data pool, the auxiliary tool 16, described in more detail below, is designed to acquire long term data from the short-term data 20. In addition to building long-term data 22 also in a binary file format, the auxiliary tool 16 has as will be described below many advanced features.

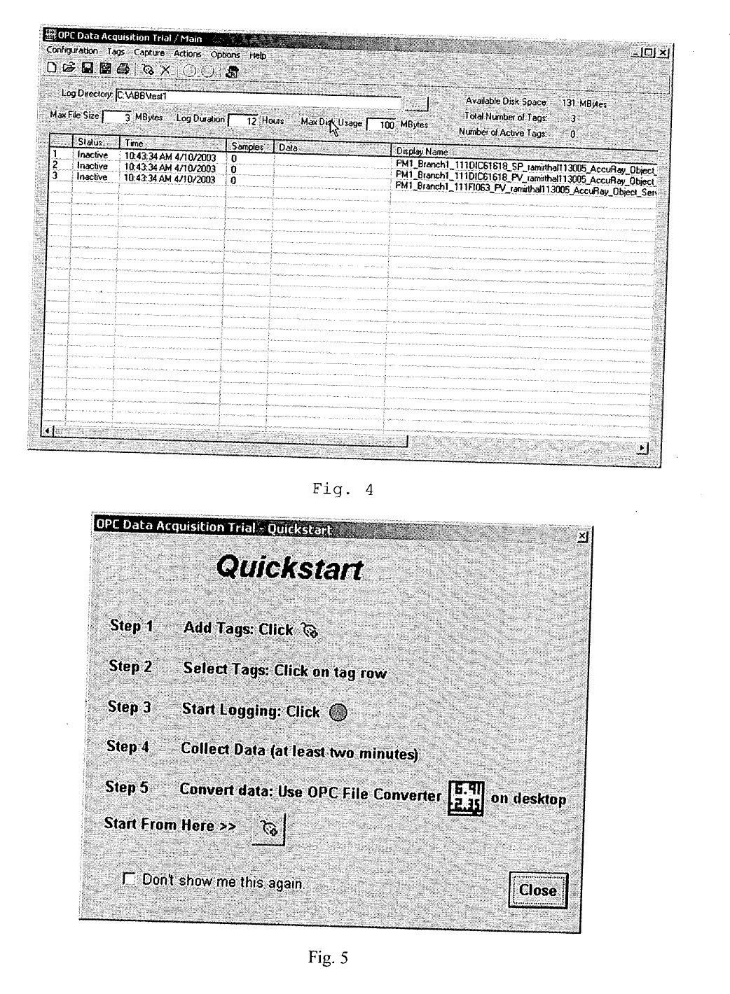

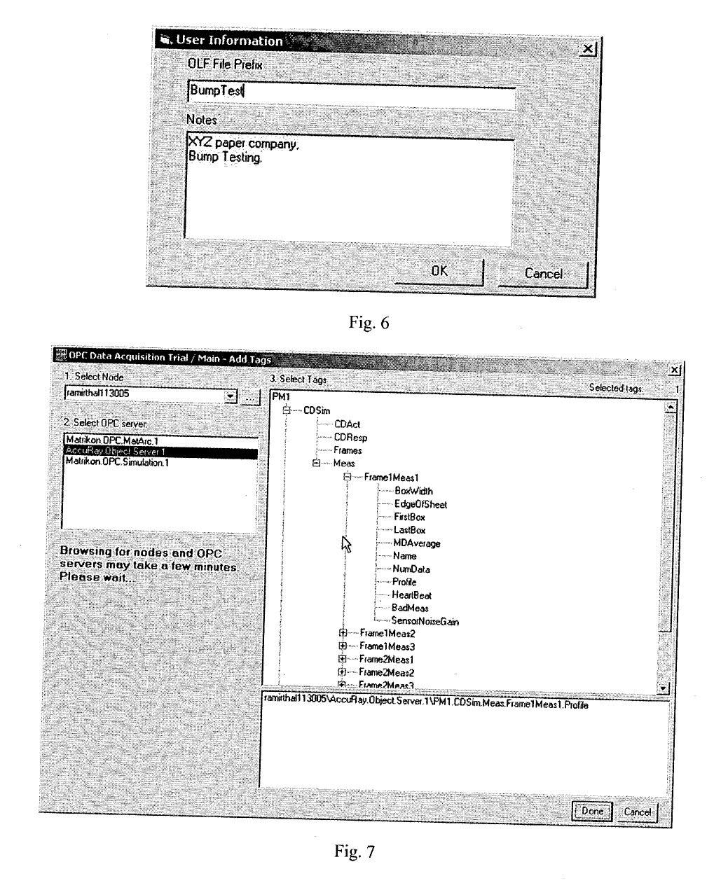

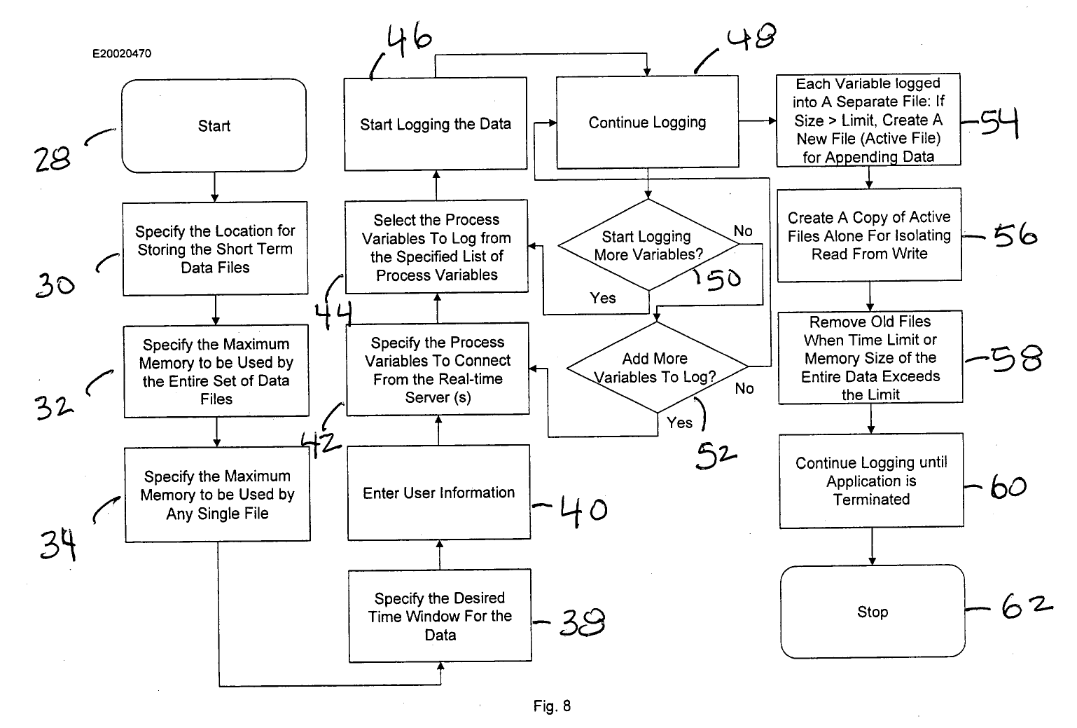

Screen shots of the data acquisition tool 14 are shown in FIG. 4-7. FIG. 5 shows the main window for the data logger 14 and the steps required for logging and processing the logged data is provided in a flash screen of FIG. 4 which shows a list of tags. The form shown in FIG. 6 allows the user to enter user information to be stored with the log data.

As mentioned earlier, four main parameters that a user can choose for logging are the location of the log files, the time duration for collecting the data, maximum total file size, and maximum individual file size. The present invention has connectivity for an OPC (OLE for process control, http://www.opc.org) server; however, the design of this application is general for any real-time data server and can be used with any server that serves real-time data as a time-value pair.

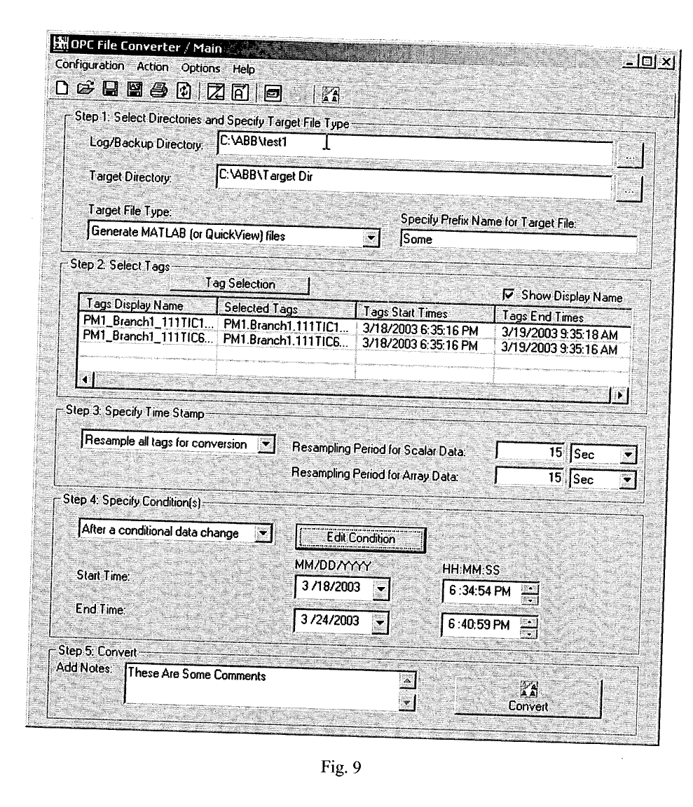

After browsing the process tags, see FIG. 7, and adding required tags, the user can select an alternative short/convenient name for later use which is also saved with the data and tag name. The selected tags appear on the bottom right window and can be deleted by clicking on the respective tag in the list.

From the list of tags as shown in FIG. 4, the user selects the tags to be logged and presses the eighth button from the left shown in the top row of icons in FIG. 4 to start logging. The button to the right of the start button is used for stopping the logging of any individual or group of tags.

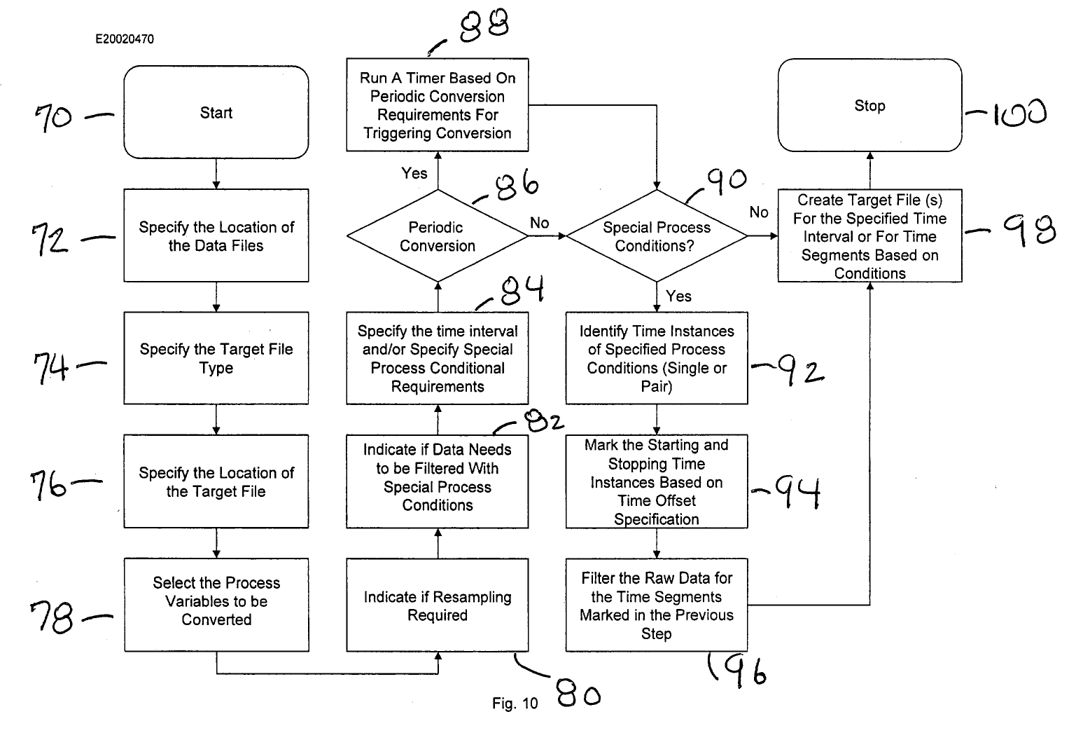

The working principle of the data logging tool 14 is given in FIG. 8. After the tool starts in 28, the user of the tool:

specifies in 30 the location for storing the short term data,

then specifies in 32 the maximum hard disk memory to be used by the entire set of data files,

then specifies in 34 the maximum hard disk memory to be used by any single file,

then specifies in 38 the desired time window for the data; and

then in 40 enters the user information.

The user then specifies in 42 the process variables to connect from the real-time server(s) and in 44 selects the process variables to log from the list of process variables specified in 42. The logging starts in 46 and continues in 48.

During a continuous data logging process, a possible interruption to start logging more variables in the list as shown in FIG. 4 is represented by the ‘Yes’ option in 50 and in the absence of which, as represented by the ‘No’ option in 50, there is another possible interruption. The initiation of this other possible interruption is depicted as ‘Yes’ in 52 and the absence of which is depicted by ‘No’ in 52. As a result, in 50, a determination is made if more variables on the list specified in 42 should be logged. If yes, the tool returns to 44 so that the user can select the process variables to log from the list of variables specified in 42. If no, the tool returns to 52 to determine if more variables should be added to the list specified in 42. If yes, the tool returns to 42 so that the user can specify more process variables to connect from the real time server(s). If no, the tool returns to 48 where the logging continues. Removing variables is performed in the same manner as adding variables to the list and logging more variables from the list is performed in the same manner as logging less variables.

During the logging, the tool proceeds to 54 where a new file is created for each variable logged and as a part of the continue logging 48 if the size of that variable is greater than the limit specified in 34, a new file is opened for logging new data.

Although there is no restriction for the logger 14 on the maximum duration of the data, the normal practice is to typically keep the short-term duration to be approximately less than 60 hours. The design of the auxiliary tool 16 allows the user to accumulate the long-term data in a central storage area by appending it from the short-term data location. The frequency of data update in the long-term archive can be periodic, or need-based. One example for a need based updating is when there is a requirement for converting data from the long term data while periodic update is not due at the time of data requirement at which a one-time need arises to update the central archive followed by conversion from the long-term data.

In addition to the capability of constructing long term data, the auxiliary tool 16 is also designed with the data merging functionality to merge any two data sets (longterm-shortterm or longterm-longterm) with any combination of process variables in each set. When the user merges two sets with uncommon tags, the tools combines all the tags and allows the user to select tags from the full set.

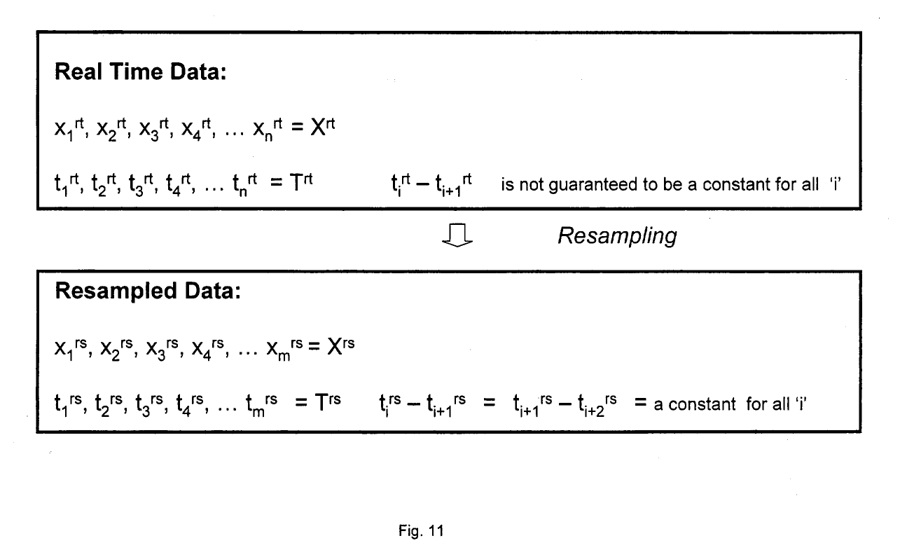

The auxiliary tool 16, a screen shot for which is shown in FIG. 9, is designed to be multi-functional to meet the many objectives of an engineer or operator who handles the plant data. No matter what form the data is stored, the user always has the necessity to convert this data in a form that can be easily imported into another application. The tool 16 is designed to support converting the raw data in 20 and/or 22 to a set of commonly useful data file formats with the capability of extending this feature for new file formats. An example list of such file formats would be MATLAB® data file format, Two ASCII file format for Scalar and Array Tags, and the XGP and AGP file formats available as of the filing date of the U.S. patent application for this invention application from the assignee of the present invention.

The working principle of the auxiliary tool 16 is given in the flowchart of FIG. 10. After the tool starts in 70, the user of the tool:

specifies in 72 the location of the data files;

then specifies in 74 the target file type;

then specifies in 76 the location for the target file;

then specifies in 78 the process variables to be converted;

then indicates in 80 whether resampling is required;

then indicates in 82 if the data needs to be filtered for special process conditions; and

then specifies in 84 the time interval and/or the special process conditional requirements.

The tool 16 then determines in 86 if periodic conversion is needed. If yes, the tool in 88 runs a timer based on the periodic conversion requirements for triggering conversion. If no, the proceeds to 90 where it determines if there are special process conditions. If no, then the tool proceeds to 98 where it creates the target file(s) for the specified time interval or for the time segments based on conditions. The tool then proceeds to stop 100.

If the tool in 90 determines that there are special process conditions, it proceeds to 92 where it identifies times instances of specified process conditions, either single or a pair. The tool then proceeds to 94 where it marks the starting and stopping time instances based on the time offset specification. The tool then proceeds to 96 where it filters the raw data for the time segments marked in 94. The tool then proceeds to 98 where it creates the target file(s) for the specified time interval or for the time segments based on conditions. The user can eliminate specified time segments if not interested in them using a selection list that appears before conversion. The tool then proceeds to stop 100.

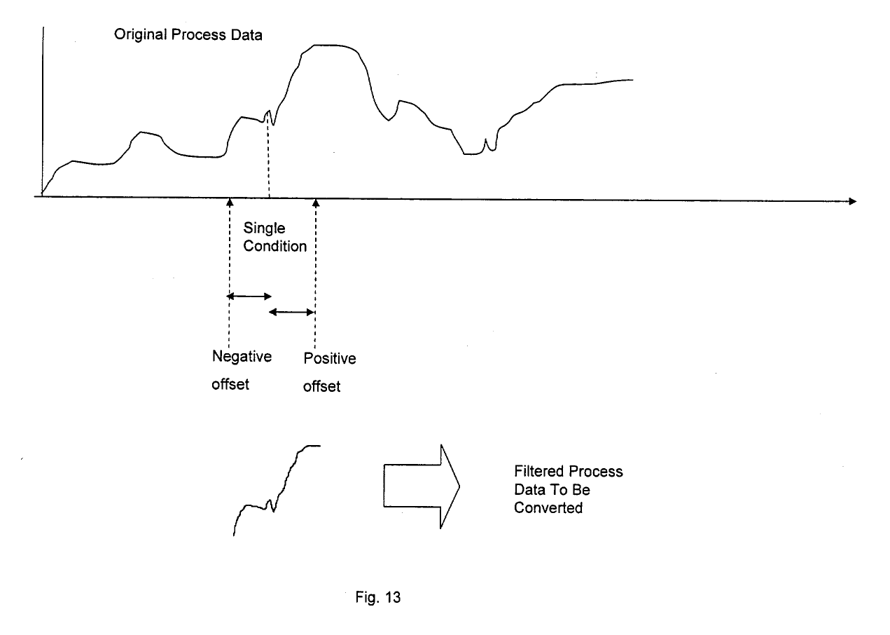

As is described above, the user of the auxiliary tool 16 indicates in 80 if resampling is required. The original real-time data stored as asynchronous tag data and the requirement for re-sampling is very common. As the tags include both scalar and array tags and with the fact that array tags are not as frequently changing as the scalar tags in most cases, the design of the auxiliary tool 16 allows different sampling times for scalar and array tags. FIG. 12 shows the resampling algorithm and the working principle of the algorithm are shown in 110 to 138 of FIG. 12 and the definition of the variables used in that algorithm are given in FIG. 11.

In addition to the capability in 84 of FIG. 10 to extract data between time instances specified explicitly, the auxiliary tool 16 of the present invention is designed to provide the user with advanced options, see 92 and 94 of FIG. 10, for filtering the data. In one form, the user can capture instances of a single specified process behavior in the data. In another form, the user can capture two instances simultaneously with a pair of specified consecutive process behaviors in the data. The act of specifying a single process behavior for capturing individual instances in a time-line is called herein a single-point condition specification. The act of specifying a pair of behaviors is called a start-stop condition specification.

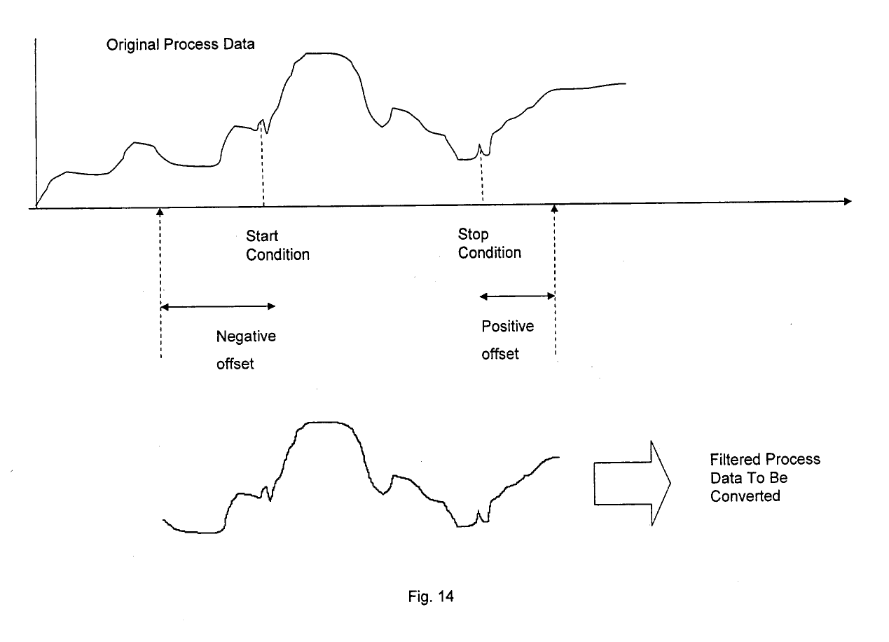

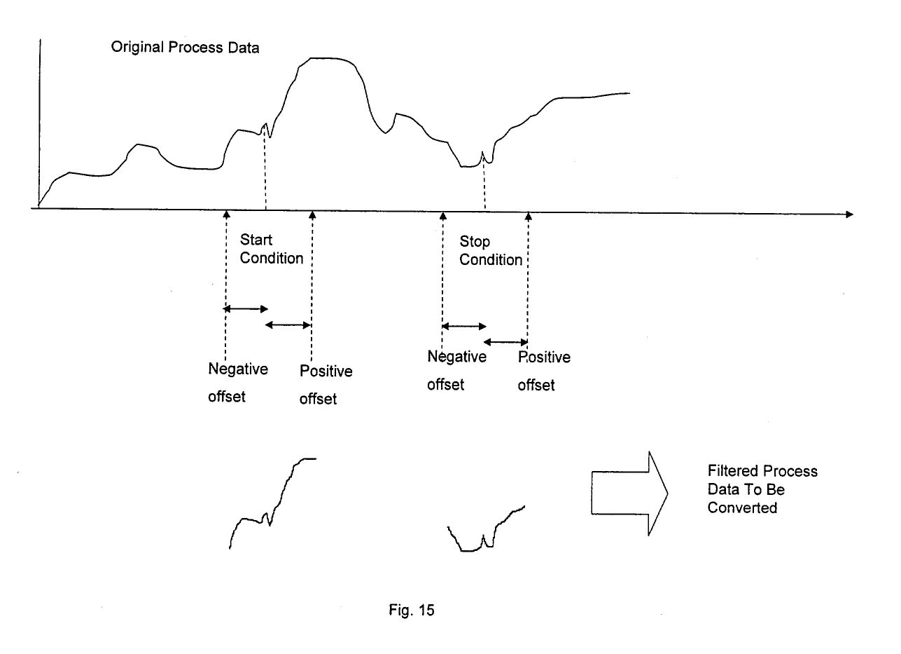

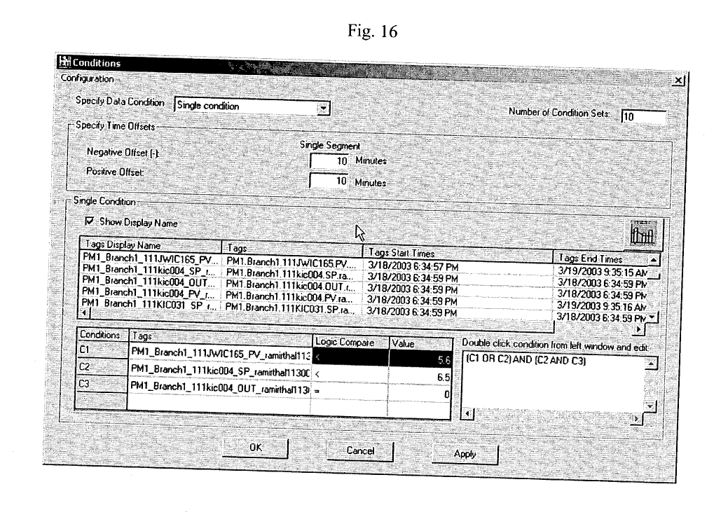

In addition, the present invention allows the user to visually inspect the process in the form of profile plots before specifying the conditions in a mathematical form in 82. The accompanied feature for identifying the single-point condition is to specify, as is shown in FIG. 13, the negative and positive offsets in time units whereby the user can obtain data around the instances exactly as required. A similar feature designed for the start-stop conditions is to specify, as is shown in FIG. 15, negative and positive offsets for both the start and stop conditions if the requirement is to obtain two sets of data around the start and stop condition. If the data requirement is to cover the duration between the start and stop condition, the present invention also allows the user to specify, as is shown in FIG. 14, the negative offset alone for the start condition and positive offset alone for the stop condition.

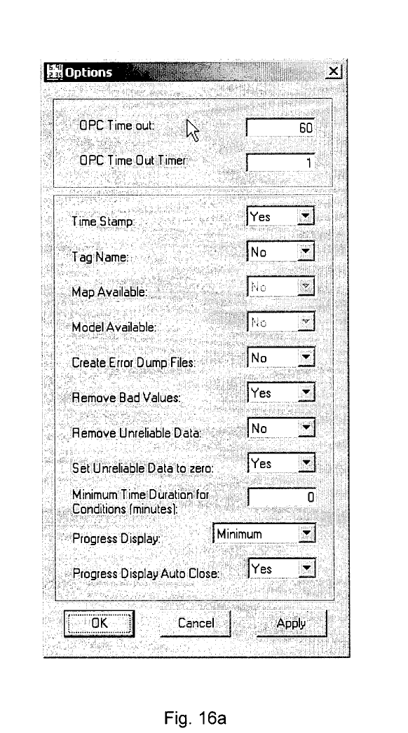

The specification of the single or start-stop condition can be as complex as required and FIG. 16 shows a screen shot showing how the condition(s) are specified. The main feature of using a display name (see the middle of FIG. 16) in addition to the tag name is that in specifying conditions, the user is also given the option of choosing the display name which helps in specifying the conditions.

While extracting data and converting that data by either using simple options or advanced options yields the results of conversion in the form of files that can be imported in any application, automation of the periodic conversion is a feature whereby the auxiliary tool 16 (see the screen shot of FIG. 9) can create files routinely as the new data is updated either in the long-term form or in the short-term form. This feature is very useful for periodic remote monitoring of the process using any tool of the choice of the user.

It should be appreciated that the auxiliary tool 16 has the functionality of an online tool as well as the offline tool. The auxiliary tool 16 is designed to accept user options as shown in FIG. 16a.

The working principle of the Data Viewer Tool 18 of FIG. 2 is shown in FIG. 17. Tool 18 is an analysis/display tool that uses the long-term and short-term data for history viewing and has the online component for online viewing. The user specifies the location of the short and long term data files in 142 and selects the online/history mode for displaying data in 144.

The tool 18 can be used as an offline tool alone, or as an online tool. The user selects the type of analysis and display in 146. However, the main strength of the Data Viewer tool 18 comes from the smooth transition between the online and offline displays. This smooth transition capability is used by the tool to intelligently switch between the online and offline displays based on the computing requirements of individual analysis. For example, if the display chosen by the user in 146 requires high computation of the data, the mode of operation of the Data Viewer Tool is in 148 to automatically switch into offline. When the chosen computation intensive analysis based display is closed, the tool in 152 returns automatically to the online mode. The online/offline status is indicated on the main display while switching between the two modes of operation.

It is to be understood that the description of the preferred embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A method for storing and retrieving scalar and array data associated with one or more processes from a real time server comprising:
a. receiving predetermined categories of said scalar and array data simultaneously from said real time server, said predetermined categories comprising good data and uncertain data;
b. reorganizing the received data into a predetermined structure to accommodate said scalar and array data;
c. categorizing said good data as reliable data and resetting all of said received scalar and array data that is in the category of unreliable data to a constant large positive value of data;
d. saving the good data and said data of constant large positive values as short term data;
e. periodically at one frequency constructing long term data from the short term data; and
f. converting, one time or periodically at another frequency, based on predetermined selection criteria that defines predetermined desired segments of data:
(i) short term data into a selected set of data and in a selected file format; or
(ii) long term data into a selected set of data and in a selected file format.

2. The method of claim 1 wherein said converting is with resampling.

3. The method of claim 1 wherein said converting is without resampling.

4. The method of claim 1 wherein new long term data can be created by merging any existing long term data and short term data or by merging two existing long term data.

5. The method of claim 1 wherein said predetermined selection criteria comprises one or more criteria selected from tag selection; time window selection; special process condition selection comprising single point selection or double point selection, with or without offsets, said double point selection producing either single or double segments.

6. The method of claim 1 wherein said selected file format is selected from an expandable list of formats.

7. The method of claim 6 wherein said expandable list of formats comprises MATLAB, XGP/AGP, ASCII formats.

8. The method of claim 5 wherein said process condition selection is assisted by graphical utility to inspect the process condition, said graphical utility displays the profile of any selected process of said one or more processes.

9. The method of claim 2 wherein said resampling includes optimizing the time it takes for resampling large sets of data.

10. The method of claim 2 wherein said resampling includes first order backward looking hold as well as first order forward looking hold for resampling with a short sampling time compared to the data change frequency.

11. A method for storing, retrieving and displaying scalar and array data associated with one or more processes from a real time server comprising:
a. receiving predetermined categories of said scalar and array data simultaneously from said real time server, said predetermined categories comprising good data and uncertain data;
b. reorganizing the received data into a predetermined structure to accommodate said scalar and array data;
c. categorizing said good data as reliable data and resetting all of said received scalar and array data that is in the category of unreliable data to a constant large positive value of data;
d. saving the good data and said data of constant large positive values as short term data;
e. periodically at one frequency constructing long term data from the short term data;
f. connecting a display tool to said short term and long term data for historical data display purposes;
g. connecting said display tool to said real time server for on-line data display purpose; and
h. switching between on-line and off-line data based on computational requirements of the type of display.

12. The method of claim 11 further comprising:
converting, one time or periodically at another frequency, based on predetermined selection criteria that defines predetermined desired segments of data:
(i) short term data into a selected set of data and in a selected file format; or
(ii) long term data into a selected set of data and in a selected file format.

13. A system for storing and retrieving scalar and array data associated with one or more processes comprising:
a real time data server providing said scalar and array data associated with said one or more processes;
means for receiving predetermined categories of said scalar and array data simultaneously from said real time server, said predetermined categories comprising good data and uncertain data;
means for reorganizing the received data into a predetermined structure to accommodate said scalar and array data;
means for categorizing said good data as reliable data and resetting all of said received scalar and array data that is in the category of unreliable data to a constant large positive value of data;
means for saving the good data and said data of constant large positive values as short term data;
means for periodically at one frequency constructing long term data from the short term data; and
means for converting, one time or periodically at another frequency, based on predetermined selection criteria that defines predetermined desired segments of data:
(i) short term data into a selected set of data and in a selected file format; or
(ii) long term data into a selected set of data and in a selected file format.

14. A system for storing, retrieving and displaying scalar and array data associated with one or more processes comprising:
a real time data server providing said scalar and array data associated with said one or more processes;
means for receiving predetermined categories of said scalar and array data simultaneously from said real time server, said predetermined categories comprising good data and uncertain data;
means for reorganizing the received data into a predetermined structure to accommodate said scalar and array data;
means for categorizing said good data as reliable data and resetting all of said received scalar and array data that is in the category of unreliable data to a constant large positive value of data;
means for saving the good data and said data of constant large positive values as short term data;
means for periodically at one frequency constructing long term data from the short term data;
means for connecting a display tool to said short term and long term data for historical data display purposes;
means for connecting said display tool to said real time server for on-line data display purpose; and
means for switching between on-line and off-line data based on computational requirements of the type of display.
